(19) United States
(12) Patent Application Publication
(10) Pub. No.: US 2014/0139026 A1
(43) Pub. Date: May 22, 2014

(54) SENSING DEVICE CAPABLE OF CONVERTING OPTICAL ENERGY INTO ELECTRICAL ENERGY AND CONVERSION METHOD THEREOF

(71) Applicant: INSTITUTE FOR INFORMATION INDUSTRY, Taipei City (TW)

(72) Inventors: Ming-Cheng LIN, Kaohsiung City (TW); Chin-Shun HSU, Kaohsiung City (TW); Po-Cheng HUANG, Sihu Township, Yunlin County (TW)

(73) Assignee: INSTITUTE FOR INFORMATION INDUSTRY, Taipei City (TW)

(21) Appl. No.: 13/712,457

(22) Filed: Dec. 12, 2012

(30) Foreign Application Priority Data
Nov. 16, 2012 (TW) 101142847

(51) Int. Cl. G05F 3/08

(52) U.S. Cl. CPC G05F 3/08
USPC 307/43; 323/304

(57) ABSTRACT

A sensing device capable of converting optical energy into electrical energy and a conversion method thereof are presented. The sensing device includes an optical-to-electrical conversion module, a power regulation module, a sensing module, and a processing module. The optical-to-electrical conversion module is used for converting optical energy into electrical energy. The power regulation module is used for generating a power supply specification according to the electrical energy. The sensing module performs sensing according to the electrical energy to provide a sensing signal. The processing module processes the sensing signal according to the electrical energy.

CROSS-REFERENCE TO RELATED APPLICATION

This application claims the benefit of Taiwan Patent Application No. 101142847, filed on Nov. 16, 2012, which is hereby incorporated by reference for all purposes as if fully set forth herein.

### BACKGROUND OF THE INVENTION

1. Field of Invention

The present invention relates to a sensing device capable of converting optical energy into electrical energy as an independent power source, and more particularly to a sensing device that is applicable to a greenhouse having a stable illuminant and is capable of generating electrical energy as a power supply through optical-to-electrical conversion so as to perform sensing operations without batteries or external power sources.

2. Related Art

In the prior art, in greenhouse, to know changes in the cultivation environment of the greenhouse and to analyze the growing condition of the plants, sensors are arranged at many places of the cultivation environment. However, the sensors require power sources, and it is complex for disposing power lines and communication lines when the sensors are configured at various places of the site, causing inconvenience to configuration and maintenance. Therefore, manufacturers mostly use wireless sensors instead to reduce above problem. However, when the wireless sensor is used, a battery or electrical energy storage for power supply must be configured in the wireless sensor. As a result, checking if the wireless sensor operates normally by the manufacturers needs to do periodically or within the shortest service life of the power supply component through any detection means. IF the wireless sensor is unable to operate normally, an operation of replacing the battery, the power-saving component, or the wireless sensor must be performed. Since there are numerous wireless sensors, each wireless sensor is arranged at a different position, and states of the batteries or electrical energy storages for all wireless sensor are different, the operation is quite complicated and inconvenient. If periodical full replacement is adopted, the cost is increased. Therefore, a solution to the problem of checking and replacing power sources is required in the industry.

### SUMMARY OF THE INVENTION

The technical aim of the present invention is to provide a sensing device, which generates, through optical-to-electrical conversion, electrical energy for independent operation so as to perform sensing operations.

To achieve the above objective, the present invention provides a sensing device capable of converting optical energy into electrical energy, which comprises an optical-to-electrical conversion module, a power regulation module, a sensing module, and a processing module. The optical-to-electrical conversion module is used for converting optical energy into electrical energy. The power regulation module is used for adjusting the electrical energy to generate a power supply specification. The sensing module performs a sensing operation according to the electrical energy to generate a sensing signal. The processing module performs a processing operation on the sensing signal according to the electrical energy.

The present invention further provides a method for converting optical energy into electrical energy of a sensing device, which comprises: an optical-to-electrical conversion module converting optical energy into electrical energy; a sensing module performing a sensing operation to generate a sensing signal when obtaining the electrical energy; and a processing module performing a processing operation on the sensing signal when obtaining the electrical energy.

The sensing device provided in the present invention can operate under a illuminant, so the sensing device does not need to be provided with a power source, for example, provided with a power cord or equipped with a battery or a electrical energy storag, thereby reducing the overall setup cost and subsequent maintenance labor cost. The present invention is especially applicable to a site having a large number of stable illuminants, for example, a greenhouse having artificial illuminants. In addition, in the present invention, with the electrical energy adjustment capability of the power regulation module, power can be supplied to elements of the whole sensing device efficiently so as to improve the operating performance of the sensing device. Further, in the present invention, multiple sensing modules can be connected through the power regulation module to perform sensing operations so as to reduce the setup cost.

### BRIEF DESCRIPTION OF THE DRAWINGS

The present invention will become more fully understood from the detailed description given herein below for illustration only, and thus are not limitative of the present invention, and wherein:

FIG. 1 is a schematic view illustrating a first structure of a sensing device according to an embodiment of the present invention;

FIG. 2 is a schematic view illustrating a second structure of a sensing device according to an embodiment of the present invention;

FIG. 3 is a schematic view illustrating a third structure of a sensing device according to an embodiment of the present invention;

FIG. 4 is a schematic view illustrating a flow of converting optical energy into electrical energy of a sensing device according to an embodiment of the present invention; and

FIG. 5 is a schematic view illustrating a detailed flow of converting optical energy into electrical energy of a sensing device according to another embodiment of the present invention.

### DETAILED DESCRIPTION OF THE INVENTION

Embodiments of the present invention are described in detail below with reference to the accompanying drawings.

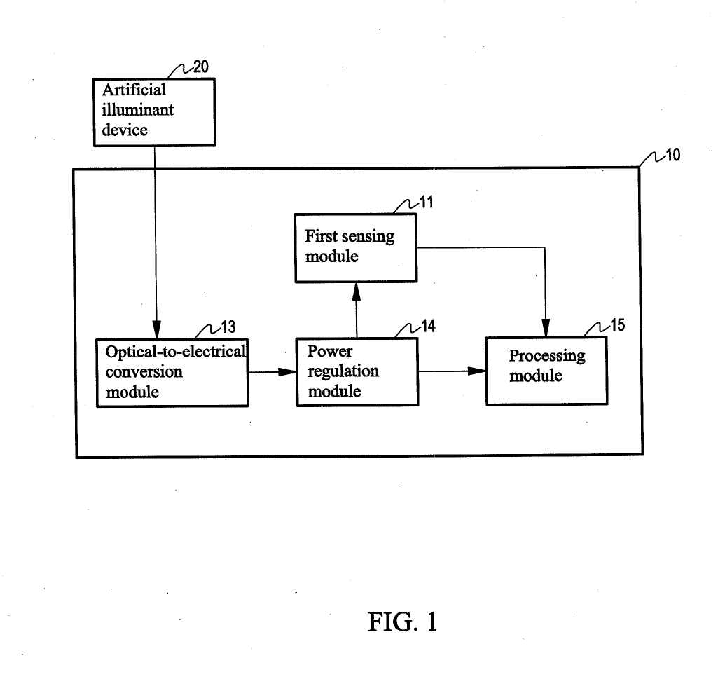

Referring to FIG. 1, it is a schematic view illustrating a first structure of a sensing device 10 according to an embodiment of the present invention. The sensing device 10 needs to be configured in a site having a illuminant. The sensing device 10 includes an optical-to-electrical conversion module 13, a power regulation module 14, a first sensing module 11, and a processing module 15. The power regulation module 14 is used for connecting to the optical-to-electrical conversion module 13, and the first sensing module 11 is connected to the power regulation module 14.

The optical-to-electrical conversion module 13 needs to be configured at a place that can be irradiated by light emitted from a illuminant. The illuminant may be a natural illuminant or an artificial illuminant device 20 configured in an indoor climate. The natural illuminant is, for example, the sun, and the artificial illuminant device 20 is, for example, a fluorescent lamp, a bulb, or a light emitting apparatus, device or component capable of emitting certain optical energy. The optical-to-electrical conversion module 13 may be a solar panel, a solar cell, or any optical-to-electrical converter or component having optical-to-electrical conversion capability. Upon receiving light emitted from the illuminant, the optical-to-electrical conversion module 13 converts optical energy into electrical energy.

The power regulation module 14 is connected to the optical-to-electrical conversion module 13, obtains the electrical energy converted by the optical-to-electrical conversion module 13, and adjusts the obtained power to generate a power supply specification. The power supply specification meets or exceeds the power requirement for operation of all elements of the sensing device 10, or meets the minimum power supply for operation of elements required to be used in different working periods during the operation of the sensing device 10, and at least meets the power supply requirement for the sensing module and the processing module 15. The adjusted electrical energy complies with the power supply specification.

The power regulation module 14 may be one of an analog-to-digital conversion unit, a digital-to-analog conversion unit, a voltage regulation unit, a rectification unit, a filtering unit, and a signal amplification unit or any combination thereof, which depends on the manner in which the designer adjusts the electrical energy to meet the requirement of the power supply specification, and is not limited.

The first sensing module 11 is connected to the power regulation module 14 to obtain the electrical energy, and may perform a sensing operation according to the obtained electrical energy when it is necessary to perform the sensing operation. According to the type of the first sensing module 11, the first sensing module 11 performs a corresponding sensing operation. For example, the first sensing module 11 may be any type of sensing module for sensing air composition, soil composition, temperature, humidity, illuminance, PH (power of hydrogen ions), light, infrared, body temperature, concentration of carbon dioxide, carbon monoxide, or oxygen, or sound of the environment.

Further, the first sensing module 11 may include more than one sensing element, for example, a combination of three sensing elements of temperature, humidity, and illuminance, for getting sense more than one environmental sensing value (of the same type or different types) at a time so as to generate one or more first sensing signals.

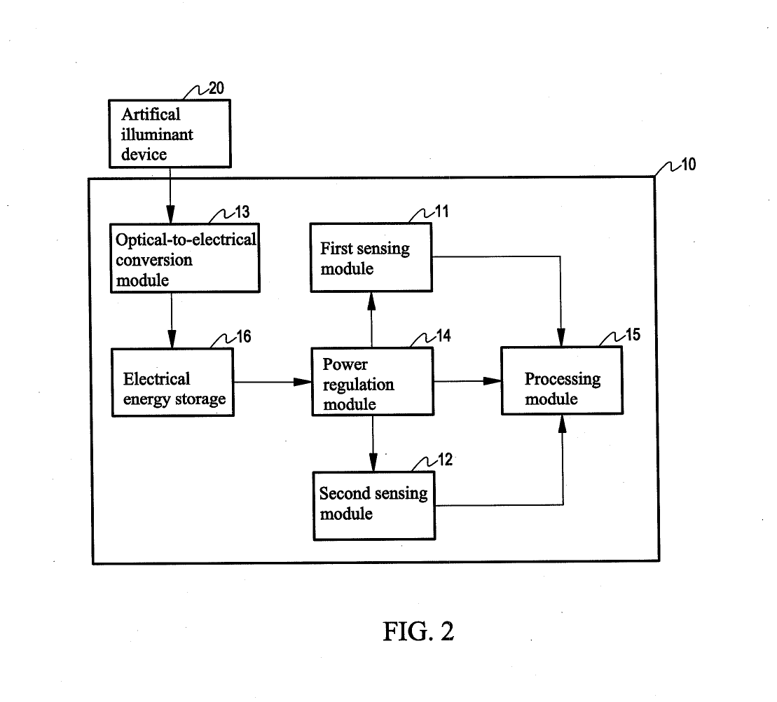

In some other embodiments, the sensing device 10 may further include a second sensing module 12 (not shown in FIG. 1, but shown in FIG. 2). The second sensing module 12 is also connected to the power regulation module 14 to obtain the electrical energy, and performs a sensing operation according to the obtained electrical energy when it is necessary to perform the sensing operation. The types and the number of sensing elements of the second sensing module 12 may be the same as, partially the same as, or completely different from those of the first sensing module 11. The second sensing module 12 may also sense to get more than one environmental sensing value at a time to generate one or more second sensing signals. If the first sensing module 11 and the second sensing module 12 are the same sensing element, the first sensing signal and the second sensing signal are the same sensing signal. On the contrary, if the first sensing module 11 and the second sensing module 12 are different sensing elements, the first sensing signal and the second sensing signal are different sensing signals. The first sensing module 11 and the second sensing module 12 may be physically arranged at adjacent positions or arranged at different positions to perform sensing operations at different positions.

After obtaining the electrical energy, the processing module 15 starts to receive the first sensing signal transmitted from the first sensing module 11 and perform a first processing operation on the received first sensing signal. The first processing operation may be analyzing the first sensing signal to generate an environmental sensing analysis result, or sampling the first sensing signal to extract a required sample signal, or compressing the signal by a compression means, or temporarily storing the first sensing signal in the space of a memory built in the sensing device 10 or in the processing module 15. However, the first processing operation may include one of analysis, sampling, compression, and storage, or any combination thereof, which is not limited and depends on the requirement of the designer. Moreover, a currently known data compression means is used, which is not described herein.

When the sensing device 10 includes the second sensing module 12, the processing module 15 also receives the second sensing signal transmitted from the second sensing module 12, and performs a second processing operation on the received second sensing signal. The second processing operation also includes one of analysis, sampling, compression, and storage, or any combination thereof. Moreover, the first processing operation and the second processing operation may be the same or different technical means, depending on the requirement of the designer.

Further, after obtaining the electrical energy, the first sensing module 11 may perform the sensing operation and transmit the first sensing signal to the processing module 15 spontaneously according to the design. For example, the sensing operation is performed by setting a sensing time table or according to a fixed time interval. In some other specific embodiments, the sensing time table or the fixed time interval may be stored in the processing module 15, and then the processing module 15 generatess a start signal according to the sensing time table or the fixed time interval and transfers the start signal to the first sensing module 11, so that the first sensing module 11 may perform the sensing operation continuously or discontinuously.

After obtaining the electrical energy, the second sensing module 12 may perform the sensing operation and transmit the second sensing signal to the processing module 15 spontaneously according to the design. Moreover, the second sensing module 12 may perform the sensing operation continuously or discontinuously.

Alternatively, after obtaining the electrical energy, the processing module 15 sends a control signal to the first sensing module 11 and the second sensing module 12 at decided tome to control the time at which the first sensing module 11 and the second sensing module 12 perform the sensing operations.

Referring to FIG. 2, it is a schematic view illustrating a second structure of a sensing device according to an embodiment of the present invention. The difference from the preceding embodiment lies in that the sensing device 10 further includes a electrical energy storage 16. The electrical energy storage 16 may be a storage battery or any other similar energy storage module, circuit, device, element, or component capable of storing electrical energy. The electrical energy storage 16 is connected to the optical-to-electrical conversion module 13 and the power regulation module 14. The electrical energy converted by the optical-to-electrical conversion module 13 is stored in the electrical energy storage 16, and the electrical energy storage 16 provides the electrical energy to the power regulation module 14, so that the power regulation module 14 adjusts the electrical energy to generate the power supply specification.

Further, the electrical energy storage 16 continuously stores the electrical energy, and supplies power to the power regulation module 14 when the electrical energy storage stores a default quantity of the electrical energy. The default quantity of the electrical energy is a necessary quantity of the electrical energy for operation of the sensing module and the processing module 15, preventing the operation of the sensing module and the processing module 15 from interruption due to low battery or electricity shortage. When the stored electrical energy is lower than the default quantity of the electrical energy, the electrical energy storage 16 suspends power supply and does not supply power until the electrical energy storage stores a default quantity of the electrical energy.

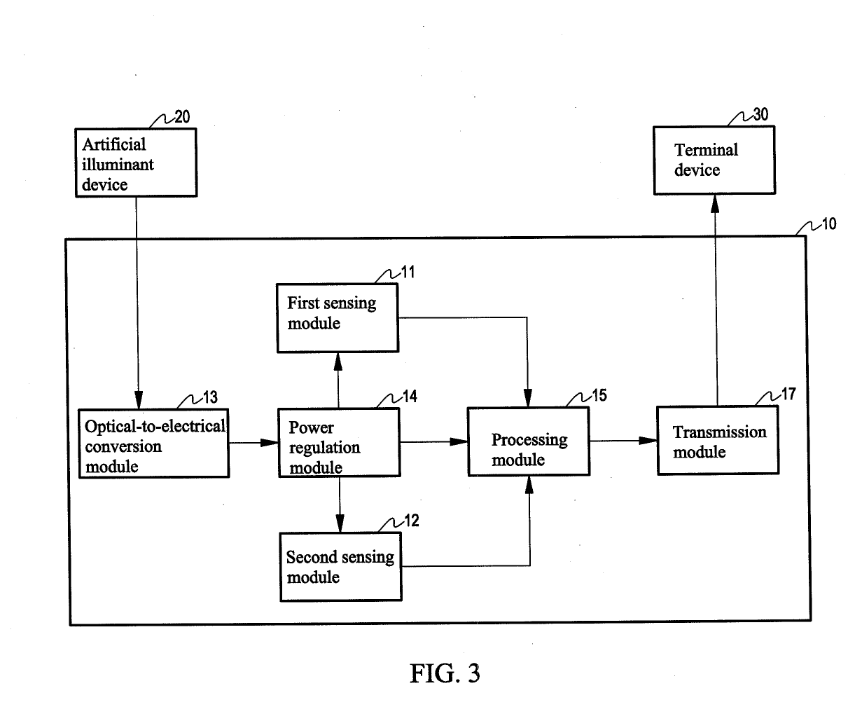

Referring to FIG. 3, it is a schematic view illustrating a third structure of a sensing device according to an embodiment of the present invention. The difference from the preceding embodiment lies in that the sensing device 10 further includes a transmission module 17 used for connecting to a terminal device 30. The transmission module 17 is connected to the processing module 15. The processing module 15 generates a processing result after (1) performing the first processing operation on the first sensing signal, (2) performing the second processing operation on the second sensing signal, or performing the two operations of (1) and (2). The processing module 15 transmits the processing result to the terminal device 30 through the transmission module 17. The terminal device 30 performs a corresponding operation after obtaining the processing result, for example, analyzes, stores, or transfers the processing result. The transmission module 17 may be a commercially available wired or wireless transmission device that communicates with the terminal device 30 through a wired or wireless communication network, which is prior art and is not described herein.

In some other embodiments, FIG. 2 and FIG. 3 show that the transmission module 17 and the electrical energy storage 16 may be configured in the sensing device 10 at the same time.

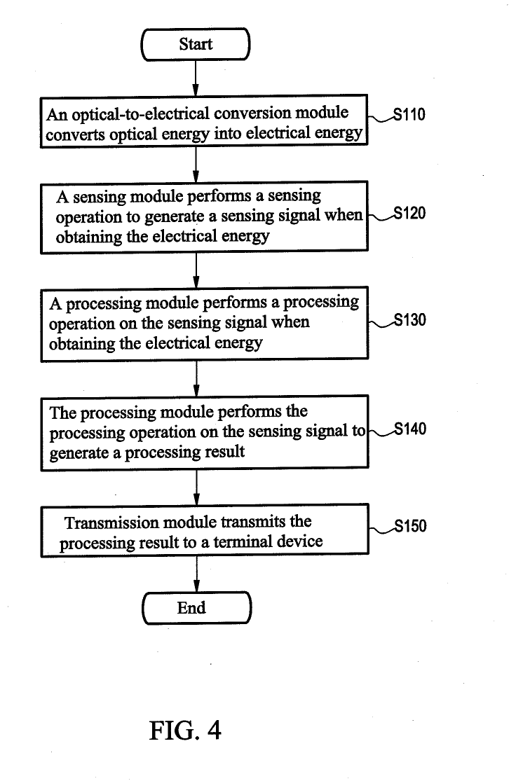

Referring to FIG. 4, it is a schematic view illustrating a flow of converting optical energy into electrical energy of a sensing device according to an embodiment of the present invention. Reference is made to FIG. 1 to FIG. 3 for ease of understanding. The method includes the following steps.

An optical-to-electrical conversion module 13 converts optical energy into electrical energy (Step S110). The optical-to-electrical conversion module 13 is configured at a place that can be irradiated by light emitted from a illuminant (a natural illuminant or an artificial illuminant device 20), and converts optical energy into electrical energy upon receiving light emitted from the illuminant.

A sensing module performs a sensing operation to generate a sensing signal when obtaining the electrical energy (Step S 120). As described above, a first sensing module 11 performs a sensing operation to generate a first sensing signal when obtaining the electrical energy. The first sensing signal is transmitted to a processing module 15.

A processing module 15 performs a processing operation on the sensing signal when obtaining the electrical energy (Step S130). As described above, when obtaining the electrical energy, the processing module 15 starts operation to receive a first sensing signal and a second sensing signal, perform a first processing operation on the first sensing signal, and perform a second sensing operation on the second sensing signal.

The processing module 15 performs the processing operation on the sensing signal to generate a processing result (Step S140). The processing module 15 generates a processing result after processing at least one of the first sensing signal and the second sensing signal, and transmits the processing result to a terminal device 30 through a transmission module 17 (Step S150), so that the terminal device 30 performs a corresponding operation according to the processing result.

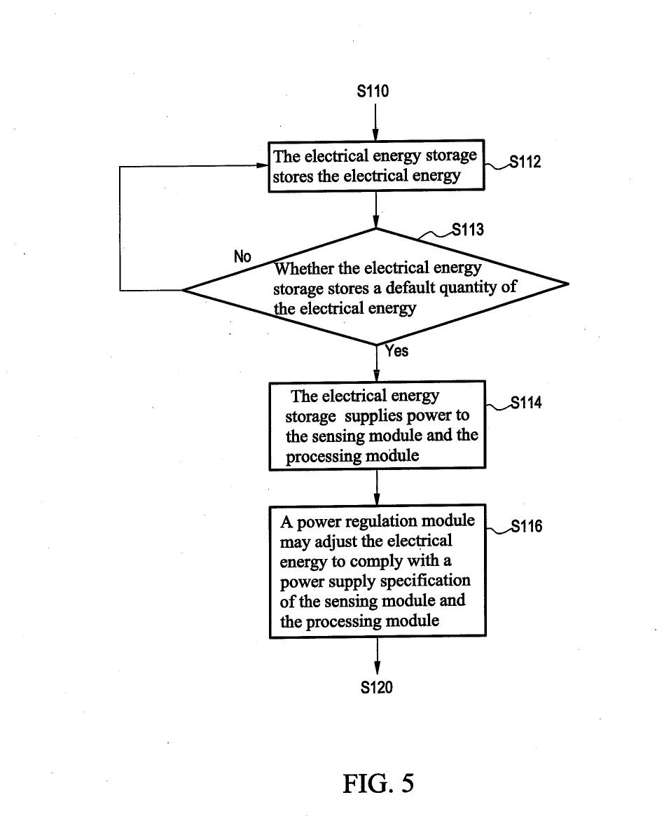

Referring to FIG. 5, it is a schematic view illustrating a further flow between Steps S110 and S120 according to an embodiment of the present invention. Between Steps S110 and S120, a power regulation module 14 may adjust the electrical energy to comply with a power supply specification of the sensing module and the processing module 15 (Step S116). The power regulation module 14 obtains the electrical energy converted by the optical-to-electrical conversion module 13, and adjusts the obtained power to generate a power supply specification. The power supply specification meets or exceeds the power requirement for operation of all elements of the sensing device 10.

Further, after Step S110 and before Step S116, a electrical energy storage 16 may store the electrical energy and supply power to the sensing module and the processing module 15. This step includes the following steps. First, the electrical energy storage 16 stores the electrical energy (Step S112). Then, it is determined whether the electrical energy storage stores a default quantity of the electrical energy (Step S113). When the electrical energy storage stores a default quantity of the electrical energy, the electrical energy storage 16 supplies power to the sensing module and the processing module 15 (Step S114). As a result, the default quantity of the electrical energy is a necessary quantity of the electrical energy for operation of the sensing module and the processing module 15. Taking FIG. 1 as an example, the default quantity of the electrical energy designated by the electrical energy storage 16 at least includes necessary electrical energy for operation of the processing module 15 and the first sensing module 11. Taking FIG. 3 as an example, the default quantity of the electrical energy designated by the electrical energy storage 16 at least includes necessary electrical energy for operation of the processing module 15, the first sensing module 11, the second sensing module 12, and the transmission module 17.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A sensing device capable of converting optical energy into electrical energy, comprising:
an optical-to-electrical conversion module, for converting optical energy into electrical energy;
a power regulation module, connected to the optical-to-electrical conversion module, for adjusting the electrical energy to generate a power supply specification;
a first sensing module, connected to the power regulation module, for performing a sensing operation according to the electrical energy to generate a first sensing signal; and
a processing module, connected to the power regulation module and the first sensing module, for performing a first processing operation on the first sensing signal according to the electrical energy.

2. The sensing device capable of converting optical energy into electrical energy according to claim 1, wherein the power regulation module comprises at least one of an analog-to-digital conversion unit, a digital-to-analog conversion unit, a voltage regulation unit, a rectification unit, a filtering unit, and a signal amplification unit.

3. The sensing device capable of converting optical energy into electrical energy according to claim 1, wherein the optical-to-electrical conversion module is a solar panel or an optical-to-electrical converter.

4. The sensing device capable of converting optical energy into electrical energy according to claim 1, wherein the first processing operation comprises performing at least one operation of analysis, sampling, compression, and storage on the first sensing signal.

5. The sensing device capable of converting optical energy into electrical energy according to claim 1, further comprising a transmission module connected to the processing module, wherein the processing module performs the first processing operation on the first sensing signal to generate a processing result, and the transmission module transmits the processing result to a terminal device.

6. The sensing device capable of converting optical energy into electrical energy according to claim 1, further comprising: a electrical energy storage , connected to the optical-to-electrical conversion module and the power regulation module, for storing the electrical energy converted by the optical-to-electrical conversion module and power supplying to the power regulation module to adjust the electrical energy so as to generate the power supply specification.

7. The sensing device capable of converting optical energy into electrical energy according to claim 6, wherein the electrical energy storage is used to store the electrical energy, and to supply power to the power regulation module when the electrical energy storage stores a default quantity of the electrical energy.

8. The sensing device capable of converting optical energy into electrical energy according to claim 7, wherein the default quantity of the electrical energy is a necessary quantity of the electrical energy for operation of the first sensing module and the processing module.

9. The sensing device capable of converting optical energy into electrical energy according to claim 1, wherein the sensing device is configured in an indoor climate having an artificial illuminant device, the optical-to-electrical conversion module is disposed under the artificial illuminant device, and a illuminant is provided by the artificial illuminant device.

10. The sensing device capable of converting optical energy into electrical energy according to claim 1, further comprising:
a second sensing module, connected to the power regulation module, for performing a sensing operation according to the electrical energy to generate a second sensing signal, wherein
the processing module is further connected to the second sensing module and used for performing a second processing operation on the second sensing signal according to the electrical energy.

11. The sensing device capable of converting optical energy into electrical energy according to claim 10, wherein the first sensing module and the second sensing module are different sensing elements, and the first sensing signal and the second sensing signal are different sensing signals.

12. A method for converting optical energy into electrical energy of a sensing device, comprising:
converting optical energy into electrical energy by an optical-to-electrical conversion module;
performing a sensing operation to generate a sensing signal when obtaining the electrical energy by a sensing module; and
performing a processing operation on the sensing signal when obtaining the electrical energy a processing module.

13. The method for converting optical energy into electrical energy of a sensing device according to claim 12, wherein after the step of conversion module converting optical energy into electrical energy by an optical-to-electrical, the method further comprises:
adjusting the electrical energy to comply with a power supply specification of the sensing module and the processing module by a power regulation module.

14. The method for converting optical energy into electrical energy of a sensing device according to claim 13, wherein the power regulation module adjusts the electrical energy in a manner comprising at least one of analog-to-digital conversion, digital-to-analog conversion, voltage regulation, rectification, filtering, and signal amplification.

15. The method for converting optical energy into electrical energy of a sensing device according to claim 12, wherein the processing operation comprises performing at least one operation of analysis, sampling, compression, and storage on the sensing signal.

16. The method for converting optical energy into electrical energy of a sensing device according to claim 12, wherein after the step of performing a processing operation on the sensing signal when obtaining the electrical energy by a processing module, the method further comprises:
performing the processing operation on the sensing signal to generate a processing result by the processing module; and
transmitting the processing result to a terminal device by a transmission module.

17. The method for converting optical energy into electrical energy of a sensing device according to claim 12, wherein after the step of an optical-to-electrical conversion module converting optical energy into electrical energy, the method further comprises:
storing the electrical energy and supplying power to the sensing module and the processing module by a electrical energy storage.

18. The method for converting optical energy into electrical energy of a sensing device according to claim 17, wherein after the step of storing the electrical energy and supplying power to the sensing module and the processing module by a electrical energy storage, the method further comprises:
storing the electrical energy by the electrical energy storage, and when the electrical energy storage stores a default quantity of the electrical energy, the electrical energy storage supplying power to the sensing module and the processing module.

19. The method for converting optical energy into electrical energy of a sensing device according to claim 18, wherein the default quantity of the electrical energy is a necessary quantity of the electrical energy for operation of the sensing module and the processing module.
